(19) United States
(12) Patent Application Publication
(10) Pub. No.: US 2020/0178720 A1
(43) Pub. Date: Jun. 11, 2020

(54) SOUS-VIDE COOKER

(71) Applicant: Alan BACKUS, Los Angeles, CA (US)

(72) Inventor: Alan BACKUS, Los Angeles, CA (US)

(21) Appl. No.: 16/780,114

(22) Filed: Feb. 3, 2020

Related U.S. Application Data
(63) Continuation-in-part of application No. 14/723,758, filed on May 28, 2015.

(51) Int. Cl. A47J 27/10; A23L 5/10; A47J 27/00; A47J 43/18; A47J 36/18

(52) U.S. Cl. CPC A47J 27/10; A23L 5/11; A23L 5/13; A47J 36/18; A47J 27/004; A47J 43/18; A23L 5/17

(57) ABSTRACT

A food holding wrapper is fabricated from malleable, thermally transmissive sheet material, and mechanically deformed to cause face-to-face contact with exterior food surfaces. A fluid filled cooking chamber provides heat to chambered fluid with sous vide cooking temperatures and durations. With air as the cooking fluid, the chamber heats fluid within the chamber to temperatures above boiling causing thermal coloring of outer food surfaces. User input directs a projected food serving time and a degree of thermal food surface coloringFluid within the cooking chamber is propelled by a motor driven impeller. The food containment wrapper which is coated on its interior surfaces with a nonstick coating. The food filled containment wrapper is vented to outside air. A user can enter a description of the food being cooked and a projected serving time, and a duration and start time of each required cooking processes is calculated from the projected serving time.

### CROSS-REFERENCE TO RELATED APPLICATIONS

This application is a Continuation-in-Part of application Ser. No. 14/723,758 filed on May 28, 2015, which is incorporated herein by reference.

### TECHNICAL FIELD

This application relates generally to cooking devices. The application relates more particularly to cooking devices for sous-vide cooking.

### BRIEF DESCRIPTION OF THE DRAWINGS

FIG. 1 shows a frontal perspective of embodiment 300.

FIG. 2 is a head-on view of controls 302.

FIG. 3 is an exploded perspective view of embodiment 300 when viewed from in front and above.

FIG. 4 is an exploded perspective view of embodiment 300 when viewed from below and behind.

FIG. 5 is a section taken through embodiment 300, as indicated in FIG. 1.

FIGS. 6 through 12 are perspectives of the assembly of containment skin 304.

FIGS. 13 through 17 are perspectives which show various ways of mounting one or a plurality of containment skin(s) 304 while they contain food.

FIG. 18 is a perspective of embodiment 300 with upper portion 306 removed. Upper portion 306 includes control/heater structure 308 with mounted components, and with attached downwardly projecting clear sidewalls 310.

FIG. 19 is a food type code table, as explained herein.

### SUMMARY

As stated, this document is a continuation in part of US Patent Application 2016/0345610. In that application, it states at the bottom of paragraph 0026: “As used herein, ‘oil’ or ‘cooking oil’ further suitably incorporates one or combinations of these materials, or any other suitable cooking fluid”.

This document further clarifies the term “suitable cooking fluid”, as described in paragraph 0026 of the parent application 2016/0345610, to specifically include air, the oldest and most widely used cooking fluid.

Embodiments herein many sous vide cook foods, without the use of high-priced vacuum bag sealers, or expensive vacuum sealed bags. Embodiments may, as a non-limiting and non-exhaustive example, use sheet formed, malleable, thermally transmissive, food containment shells, which are formed face to face against the outer contours of the food used to cook, thus efficiently conducting het into the foods being cooked. Unlike plastic bags, these shells, as a non-limiting and non-exhaustive example, being structurally rigid enough to retain their shape, even if the contained food is removed.

Pressure formation of these containment shells is substituted for vacuum used in conventional sous vide cooking, to hold vacuum bag surface in face-to-face contact with the food being cooked. Formation of these shells may be done with manual pressure, or other useful means. As non-limiting and non-exhaustive examples, a block or blocks of resilient foam might be pressed against malleable skin surfaces pushing them against foods. Or a balloon like air-filled or liquid filled bladder or bladders might press against the skins causing face-to-face food contact.

As used herein, sous vide cooking is defined as cooking foods in form fitting containment membranes, the membranes and contained food, being disposed, for directed periods of time, in precisely temperature controlled fluid.

To heat foods to sous vide and food coloring cooking temperatures, embodiments of the present application may use impeller driven hot fluid.

Embodiments of the present application may heat a cooking chamber to temperatures hot enough to cause thermal food surface coloring. This may occur at any point before, during, or after sous vide cooking.

This compares with traditional sous vide cooking which uses water which boils at any temperatures above boiling, far below temperatures required to heat color outer food surfaces.

Further, air, unlike water, is able to change its cooking temperature quickly, allowing for rapid variance of cooking temperature, even briefly, if desirable, throughout cooking. As a non-limiting and non-exhaustive example, this may at least occur during thermal food surface coloring.

Instead of conventional countdown timers used in many ovens and other kitchen appliances, embodiments of the present inventions may, as a non-limiting and non-exhaustive example, use at least an inputted projected serving time and a food description, to calculate when food preparation processes need to occur in order to achieve that projected serving time.

Embodiments may also offer, either alternatively, or as an additional feature, the ability to manually control cooking durations and temperatures.

Air herein performs similar functions as oil in the parent application 2016/034-5610. More specifically, air, not oil, is used to heat foods to sous vide temperatures. Air is also used to heat foods to higher temperatures needed to at least color outer food surfaces.

Air may be at least: easy to handle, cost free, and need little or no cleanup.

Further, as stated in parent application 2016/0345610, sous vide is expensive, typically at least because it requires costly vacuum bag sealers, and high-priced vacuum seal bags.

By contrast, embodiments of the present application may be far less expensive, at least by not requiring expensive vacuum bag sealers and high priced vacuum seal bags.

Expensive vacuum bag sealers, and high-priced vacuum seal bags, are well-known, and well-publicized deficiencies of traditional sous vide cooking.

Embodiments herein also may simplify the multistep sous vide cooking process by automatically setting all cooking conditions based on a projected serving time, and a description of the food being cooked.

Embodiments herein may also offer true “set it and come back and get it” (™) convenience by requiring a user to just perform two steps, a first step of loading the food and setting the controls, and a second step to unload and serve the food. There are no other actions required on the part of the user.

### DETAILED DESCRIPTION

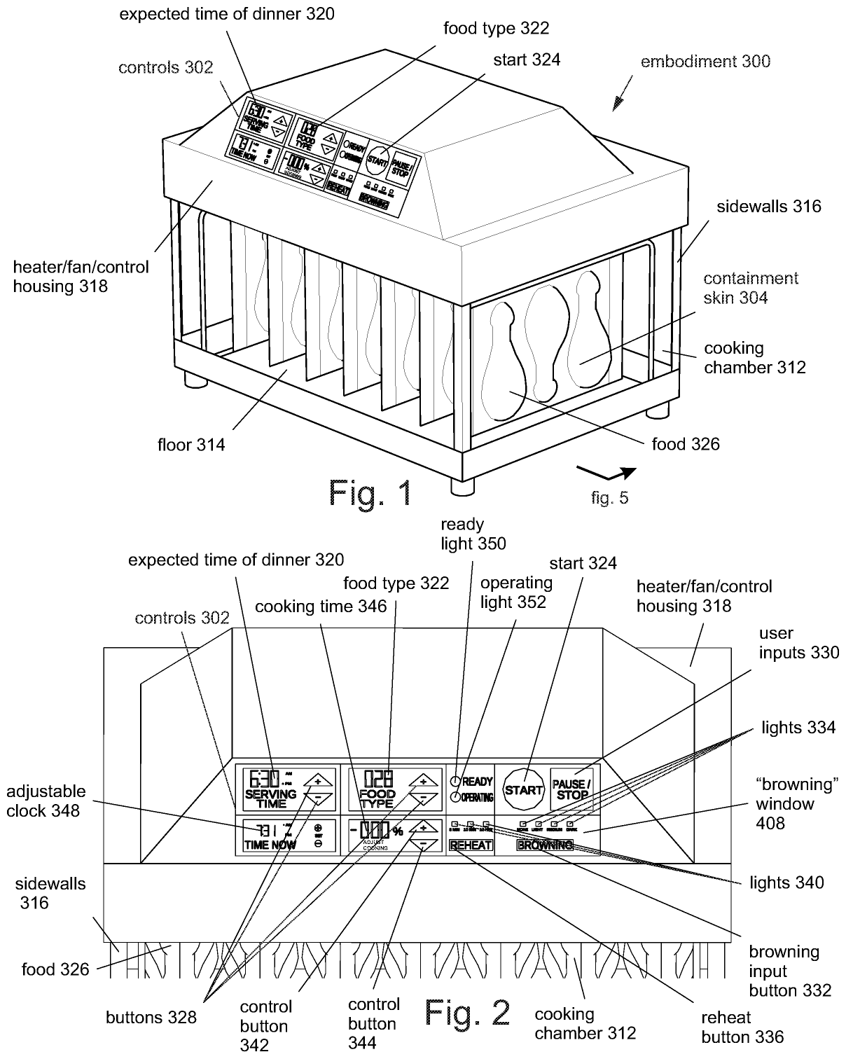

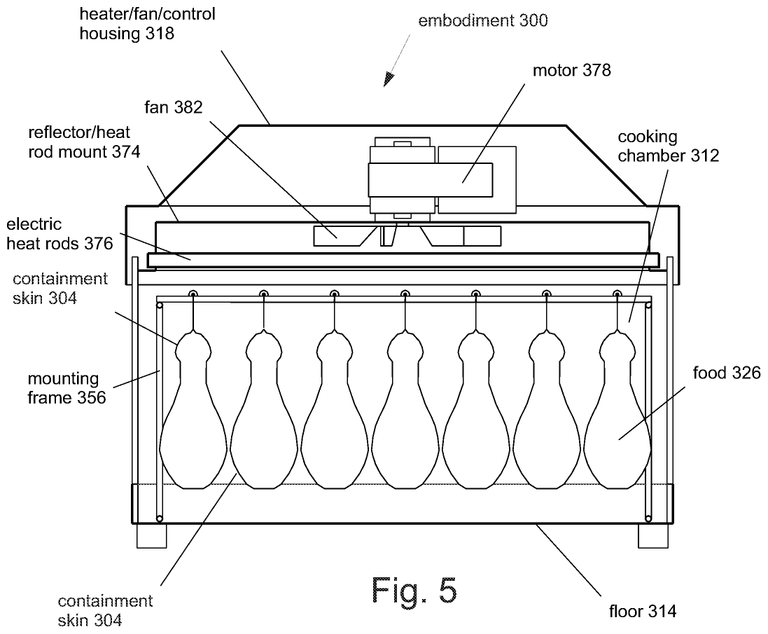

Embodiment 300 includes cooking chamber 312, which is formed by floor 314, supporting sidewalls 316, which are capped by heater/fan/control housing 318 (referring at least to FIGS. 1, 3, 4, 5, and 18).

Controls 302 on heater/fan/control housing 318 accept user inputs, as a non-limiting and non-exhaustive example, which include at least the projected food serving time, and a description of food being cooked.

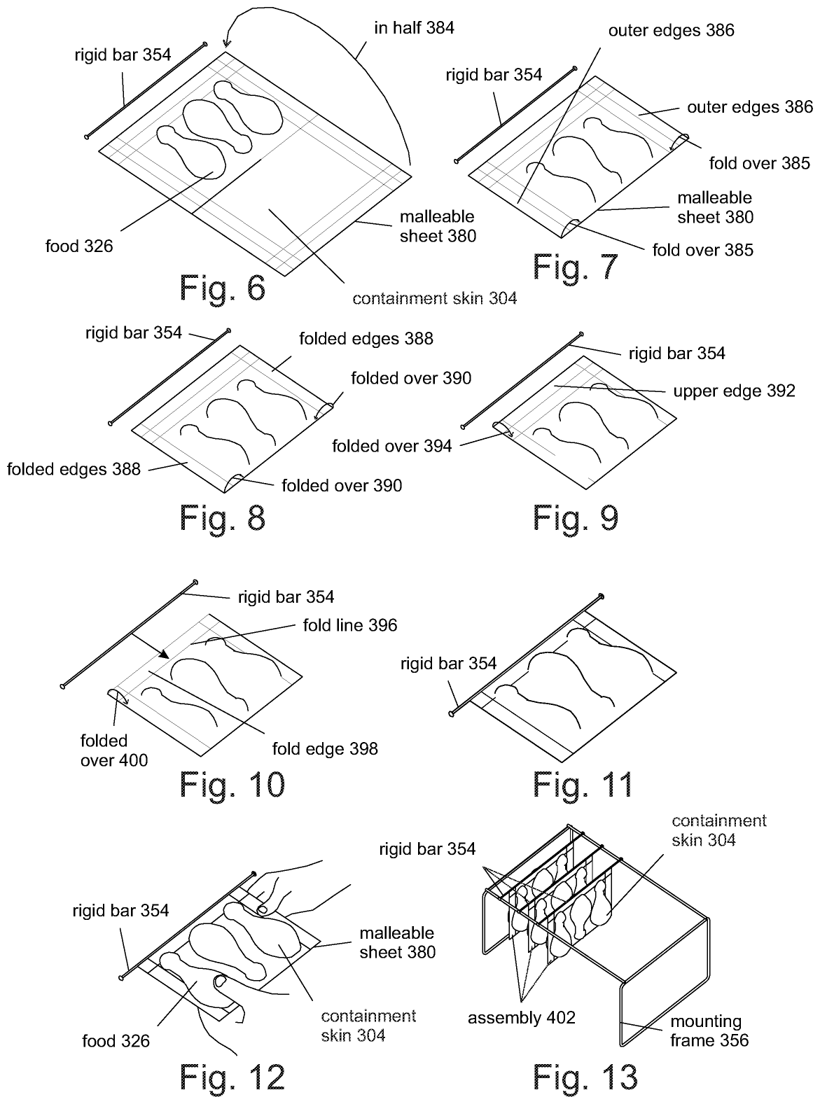

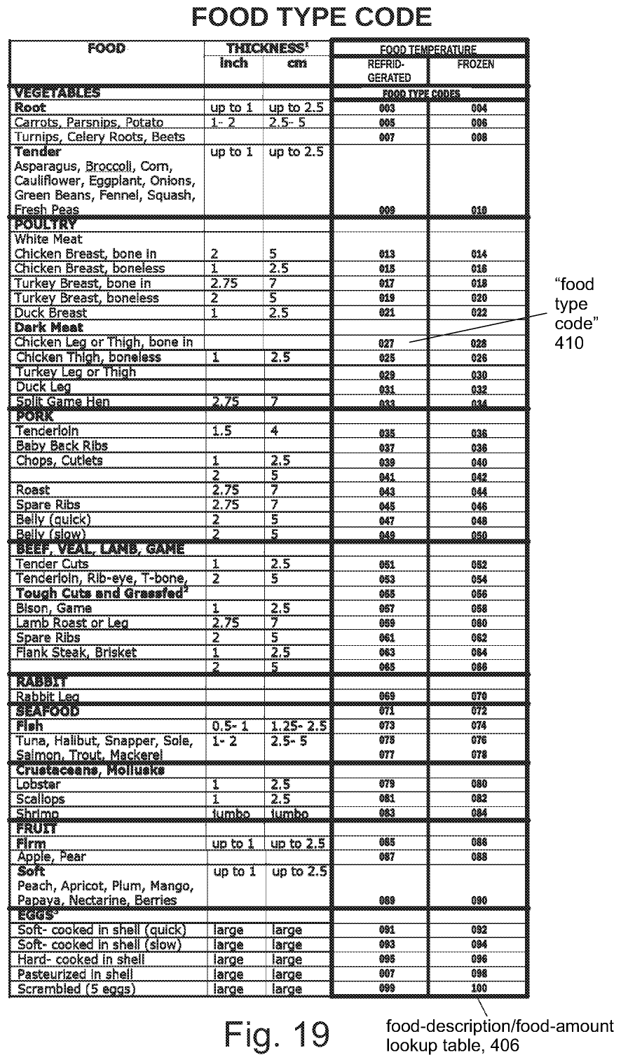

As a first non-limiting and non-exhaustive example, to use embodiment 300, food 326, in this specific example, 3 bone-in chicken legs, is wrapped (FIGS. 6 through 12) in heat transmissive, malleable containment skins 304, and loaded into cooking chamber 312 (FIG. 1), and the projected food serving time 320 of 6:30 PM and the food type 322 “028” are inputted using buttons 328. In this specific example, food type 322 is inputted as a three digit numeral, which is found, as non-limiting and non-exhaustive examples, on a food type code lookup table, such as is illustrated in FIG. 19, or on an iPhone app, or found using other means.

Pressing start button 324 then commences the cooking process.

Embodiment 300 is configured to calculate all cooking conditions, including at least cooking heat(s), and time(s). It may also optionally calculate other things such as the amount of air circulated by the fan, and/or additional heating such as non-limiting and non-exhaustive examples, by microwave or infrared, etc. The initiation of each food preparation process is calculated based on how long the process will take to do each cooking process, worked backward from the projected food serving time 320.

Medium browning the food at 350° F. takes 15 minutes, and may occur before, during, or after sous vide and/or other cooking.

Temperatures above boiling are generally needed to color food exteriors. Most foods require more than 300° F. of food cooking heat. Searing of meats, such as steaks and ribs, generally requires quickly applied heat which is typically above 350° F.

Sous vide cooking will take between 4 and 8 hours.

Sous vide cooking will thus automatically start at 2:15 PM (6:30 PM serving time, less 4 hours of sous vide cooking time, less 15 minutes of browning=(2:15 PM)).

Excellent quality food may be served at any time during sous vide cooking, and, when warmed to serving temperatures, the user may serve excellent quality food up to several hours thereafter.

As another, separate, non-limiting and non-exhaustive example, let's say at 7:30 AM, the user puts wrapped food 326 into cooking chamber 312 and appropriately sets controls 302 for a projected food serving time of 6:30 PM and a food type code of 027 which is all taken from the food type code chart shown in FIG. 19.

As soon as the user presses start button 324 at 7:30 AM, embodiment 300 immediately browns the refrigerator temperature food at 350° F. for 15 minutes, ending at 7:45 AM.

Browning the food while it is still refrigerator cool, allows higher browning surface temperatures with minimal raising of internal food temperatures.

After this 15 minutes of browning, 30 minutes of sous vide cooking follows, thus ensuring that the food is fully pasteurized. This pasteurization helps keep food from spoiling, even if it is left for several hours without being fully cooked. This, as a non-limiting and non-exhaustive example, allows setting up the cooking in the morning, and coming back in the evening and having food fresh cooked.

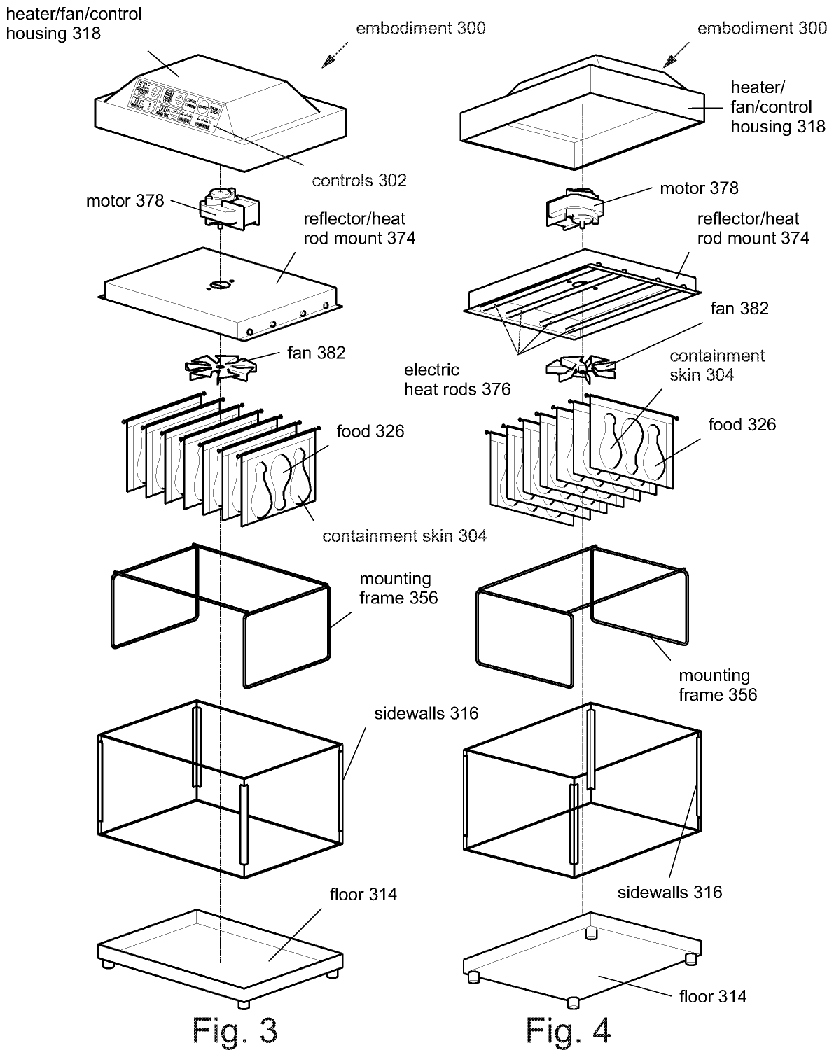

Power to electric heat rods 376 (at least FIGS. 3 and 4) is then cut off until the re-commencement of sous vide cooking at 4:30 PM (6:30 PM serving time, less 2 hours of remaining sous vide cooking time).

At this time cumulatively, 15 minutes of browning, and the minimum 4 hours of sous vide cooking has occurred, resulting in the food being medium browned and fully sous vide cooked at projected food serving time 6:30 PM.

Because sous vide cooking allows up to 4 hours of cooking time (a minimum of 4 hours up to a maximum 8 hours), food may be served perfectly sous vide cooked between 6:30 PM and 10:30 PM.

By keeping the food warm to a serving temperature of, as a non-limiting and non-exhaustive example, between 95° F. and 125° F., well-cooked sous vide food can be served for several hours after 10:30 PM.

If the food is not removed within a predetermined amount of time, all power to electric heat rods 376 may be shut off.

Temperatures and times used in sous vide cooking are well-known and amply published, as are separately, the temperatures needed to color the outside of various foods.

In part because containment skins 304 may be opened and closed at any time, before, during, or after, sous vide cooking, other food preparation steps may occur at any time. These may include, as non-limiting and non-exhaustive examples, adding seasoning or flavorings, and/or adding other ingredients, and/or performing additional food preparation steps. These steps may be programmed into embodiment 300 to automatically occur.

In this particular example, all the user set up, including wrapping and loading food into cooking chamber 312, and at least inputted settings of serving time 320, and food type description 322 (FIG. 19); may be made hours in advance of the sous vide cooking commencing. This is a major convenience, especially when compared traditional sous vide cooking which requires user presence during each stage of the sous vide cooking process (i.e. at least during bagging and vacuum sealing food, and during food loading, and later to browned the food using a frypan or other means, and finally when food is unloaded and served).

As a non-limiting and non-exhaustive example, before leaving for work in the morning, a user may load and set controls 302 on embodiment 300. A user may then come back at mealtime to find the food perfectly cooked, at the perfect serving temperature, and ready to serve, with no other processing and no intermediate steps required.

Controls 302, as a non-limiting and non-exhaustive example, may also include user input 330 to pause or stop the cooking process at any time, including at least during the sous vide cooking, reheating of foods, and browning cooking processes.

Browning input button 332 allows the user to adjust the amount of browning, as indicated by lights 334.

Reheat button 336 allows a user to reheat, within cooking chamber 312, as non-limiting and non-exhaustive examples, room temperature, or refrigerated, or frozen, or other temperature foods. When reheat button 336 is pressed, lights 340 sequentially illuminate to indicate the amount of reheating which will occur.

Control buttons 342 and 344 allow the user to percentage increase or decrease, the amount of cooking which will occur.

So, as a non-limiting and non-exhaustive example, if a user thinks that an article of food is excessively frozen or is unusually thick, they can adjust cooking time 346 up by a positive percentage (%) amount.

Adjustable clock 348 allows embodiment 300 to be standard time synchronized by a user, at least so serving time 320 is accurate according to local time.

Ready light 350 goes on whenever food being cooked is ready to be removed from cooking chamber 312 and served. So, as a non-limiting and non-exhaustive example, if the food is first ready to be served at 6:30 PM, and, with warming serving temperatures thereafter, the warming terminates at 12:30 AM; ready light 350 will be continuously on from 6:30 PM through 12:30 AM.

Operating light 352 goes on whenever embodiment 300 is turned on 324.

Referring at least to FIGS. 1, 3, 4, 5, and 18, embodiment 300 includes: floor 314 which from time to time supports clear sidewalls 316, with sidewalls 316 being removably attached to control/heater structure 308 (FIG. 18). Floor 314 in turn is configured to also support foods being cooked. Food may be mounted within cooking chamber 312 in any useful manner.

As a non-limiting and non-exhaustive example, before cooking, food 326 may be wrapped in a heat transmissive, malleable, formed sheet 380 (as a non-limiting and non-exhaustive example, formed aluminum foil), as shown in FIGS. 6 through 12. FIG. 12 shows how such a malleable sheet, possibly aluminum foil or other suitable material, might be manually formed to match outer contours of food 326 by pressing on the outer surfaces (FIG. 12) of the malleable sheet 380 causing the surfaces to form face to face contact with food 326.

Face to face contact allows efficient heat transfer through the use of conduction.

This formed construction in embodiment 300 of malleable containment skins 304 to mechanically conform to face-to-face contact against outer surfaces of food 326, is characteristically different than traditional sous vide cooking, which relies on evacuation of plastic bags, to force the bags into face-to-face contact with food 326 which is being sous vide cooked. In the real world, this means that containment skins 304 in embodiment 300 retain their formed shape, even if food 326 is removed, whereas in traditional sous vide cooking, the flexible plastic food containment bags collapse without the presence of contained food.

This malleable outer skin construction in embodiment 300, in turn, means that embodiment 300 does not need expensive vacuum bag sealing equipment to vacuum seal outer skins against outer surfaces of food being cooked.

Expensive vacuum bag sealing equipment has long been recognized as a significant shortcoming of traditional sous vide cooking.

It also means that embodiment 300 does not require the use of expensive vacuum sealed bags, as in traditional sous vide cooking.

This has also been a recognized, long-standing shortcoming of traditional sous vide cooking.

As a non-limiting and non-exhaustive example of materials which might be used, malleable containment skins 304 may be constructed using aluminum or other metal foils, or other thermally transmissive malleable sheet.

To ensure food safety, a food-contact-safe coating may be used on at least the one surface of the foil which contacts the food being cooked.

And because foods being cooked may stick to inner container surfaces, the food-contact-safe coating just described may have nonstick characteristics.

As shown at least in FIGS. 1, 13 and 18, using rigid bar 354, which is attached at the top of wrapped food 326, may allow wrapped food 326 to be suspended from mounting frame 356. Mounting frame 356 may be placed within cooking chamber 312 by resting it on floor 314 and placing sidewalls 310, and attached control/heater structure 308, on top of floor 314 (at least FIGS. 1, 13 and 18).

Mounting frame 356 allows food 326 to be freely suspended in cooking temperature air within cooking chamber 312. This may facilitate rapid and even cooking.

Other food mounting constructions may be used, at least some of which are published in well-known.

FIGS. 14 and 15, show non-limiting and non-exhaustive examples of other ways to mount food 314 within cooking chamber 312. Here, plate 358, including, integral upward spikes 360, is placed on top of floor 314, in a manner similar to mounting frame 356.

As shown in FIGS. 14 and 15, wrapped foods 362 and 364 may be rested in any useful manner on the upper ends of spikes 360. During cooking, spikes 360 provide even airflow around foods 362 and 364. This in turn may make cooking faster and more even.

As yet another non-limiting and non-exhaustive example of how foods might be mounted within cooking chamber 312, FIGS. 16 and 17 show how wrapped foods 366 and 368 might rest, in any useful disposition, on top of wavy wire frame 370. Once again, air is free to circulate around foods 366 and 368, thus promoting fast even cooking.

FIG. 18 shows a non-limiting and non-exhaustive example of one way to access cooking chamber 312 for food loading, cleaning, or for other purposes. In this example, sidewalls 310 and coupled control/heater structure 308, are removed from floor 314, by lifting 372 them upward and away from floor 314.

Other useful access door constructions are well-known, including, but not limited to, swinging an access door sideways, or downward, or upward, or providing an access opening using any other suitable means.

FIGS. 3 and 4 show perspective exploded views of embodiment 300. Here, heater/fan/control housing 318 mounts both controls 302 and reflector/heat rod mount 374. Reflector/heat rod mount 374 in turn holds heat rods 376 and motor 378. Motor 378 is coupled to, and powers, fan 382. Heater/fan/control housing 318, including mounted components, rests on top of sidewalls 316, which may be constructed from glass or plastic or other suitable material.

Sidewalls 316 in turn may rest on top of, and may be lifted off from, floor 314 (FIG. 18).

As non-limiting and non-exhaustive examples, in operation, motor 378 driven fan 382, in cooperation with controls 302, and electric heat rods 376, circulates thermostatically controlled air throughout cooking chamber 312. This heated, air movement during sous vide cooking is precisely controlled, as a non-limiting and non-exhaustive example, to match water temperatures in conventional sous vide cooking. This hot air also may be controlled to match temperatures suitable for coloring outer surfaces of food during browning portions (if used) of embodiment 300 cooking.

Embodiment 300 may be multi-functional by additionally offering: bake oven cooking, and/or air frying, and/or convection oven cooking, and/or food dehydration, and/or broiling, and/or combinations and permutations of the just mentioned, as well as other useful cooking functions.

Heat rods 376 are activated, by controls 302. As a non-limiting and non-exhaustive example, controls 302 may switch heat rods 376 on and off, and control how much power heat rods 376 receive. Controls 302 may also control when fan 382 turns on and off, and its rotational speed.

When compared to the water-filled cooking vessels of traditional sous vide cooking, heating the wrapped food contents of cooking chamber 312 using fan driven hot air allows: much faster cooking chamber warm-up, quick and even heat transfer to the foods being cooked, accurately controlled cooking heat, as well as quick high temperatures food browning.

As a non-limiting and non-exhaustive example, during sous vide cooking, embodiment 300, when activated, may at first use high power delivered to power heat rods 376 to quickly heat cooking chamber 312 to sous vide temperatures. This may be followed by much lower power settings to heat rods 376 as sous vide cooking progresses. Such power consumption modulation may help even out sous vide cooking temperatures by gently just nudging sous vide cooking temperatures up and down, rather than rapidly elevating the temperatures using a powerful heater.

Embodiment 300 may be constructed using techniques and materials such as are found, as a non-limiting and non-exhaustive example, in typical kitchen ovens.

Embodiment 300 is capable of cooking virtually all, if not all, foods that can be prepared using traditional water sous vide.

As yet another non-limiting and non-exhaustive example of an embodiment 300 work session, a user might take 3 bone in chicken legs (food 326 in FIG. 6) out of the refrigerator and place them on a sheet of aluminum foil, possibly having, on one side, a nonstick and food safe coding (malleable sheet 380 in FIG. 6) with the coated side of the foil facing the food.

Referring to FIGS. 6 through 12, the user might then fold sheet 380 in half 384 (FIG. 6) and then fold over 385 outer edges 386. Next, referring to FIG. 8, folded edges 388 might be folded over 390 yet again.

Next, referring to FIGS. 9 through 11, upper edge 392 may be folded over 394 and then rigid bar 354 placed along fold line 396.

Next, fold edge 398 is folded over 400 thus structurally trapping rigid bar 354 along fold line 396 (FIG. 12).

Venting of containment skins 304, as non-limiting and non-exhaustive examples, may be accomplished by not completely crimping one or more of the fold seams. It may also be done by perforating containment skins 304 with one or more vent holes. Some venting of containment skins 304 may be necessary at least to prevent water vapor, and/or steam from pushing containment skins 304 away from face-to-face contact with food 326, consequently at least impeding cooking heat transfer.

In FIG. 12, malleable sheet 380 is manually pressed to conform to the outer surfaces of food 326.

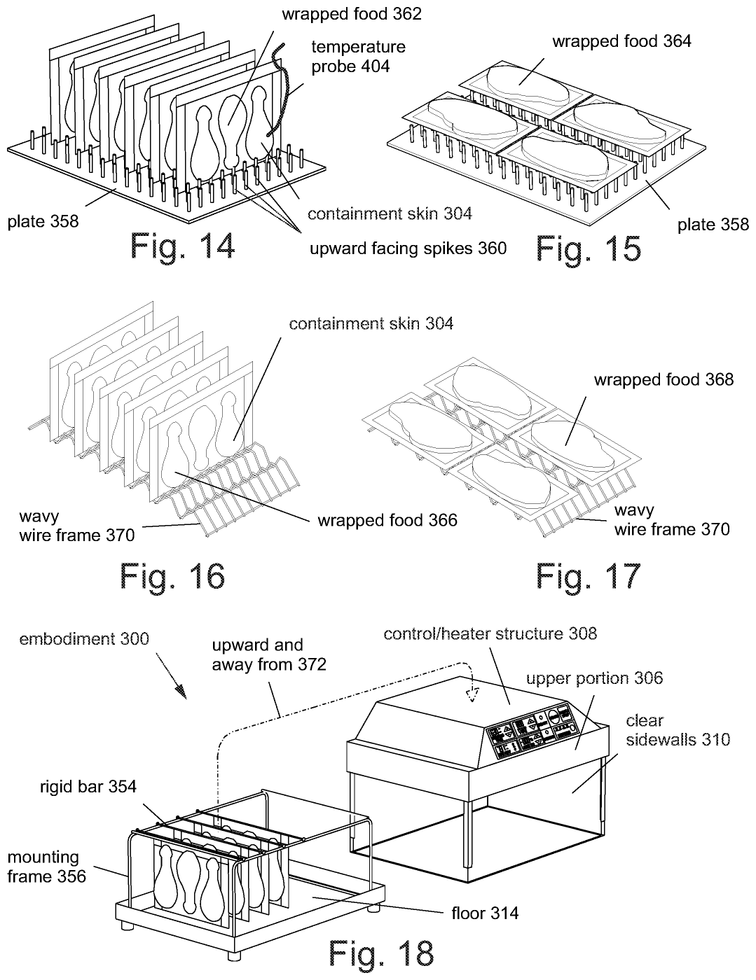

FIG. 13 shows a plurality of assembly 402′s just described, suspended from mounting frame 356.

FIGS. 1, 5, and 18 show how mounting frame 356 may be placed inside cooking chamber 312 by resting it on floor 314.

Likewise, in a similar manner, the food mounting devices shown in FIGS. 14 through 17, may also be placed inside cooking chamber 312, by resting them on floor 314. Alternatively, conventional oven racks, with multiple parallel spaced wires, may be rested above floor 314 to support foods being cooked.

Next, the user sets controls 302 as previously described.

Food heat coloring, at this time, if desirable, is set by repeatedly pressing browning input button 332.

Start button 324 is then pressed, and the user may leave embodiment 300 until the designated dining hour when cooking is completed, and the food is ready to be served.

By using fan driven heated air to sous vide cook food instead of heated water used in conventional sous vide cooking, it is much easier to quickly vary cooking temperatures throughout the sous vide process. Using programmed and/or oscillating temperature variances throughout the sous vide cooking cycle, creates the opportunity for many new cooking environments, which in turn offers a wider variety of prepared food outcomes.

Using fan driven heated air to cook foods allows cooking temperatures greater than boiling. This contrasts with traditional sous vide cooking, where temperatures above boiling would cause the heated water used to cook, to boil and evaporate. Such higher temperatures may at least be desirable to thermally color exterior food surfaces during some part of the cooking process.

Also, embodiment 300, by wrapping foods using high temperature tolerant material like, as a non-limiting and non-exhaustive example, malleable metal foil, allows high temperature surface browning of foods being cooked. This contrast with the plastic bags used to wrap food in traditional sous vide cooking, which melt and out gas at high temperatures.

Using fan driven heated air to sous vide cook also eliminates filling, emptying and handling of heavy water-filled vessels as are commonly used in traditional sous vide cooking. This in turn makes embodiment 300 much more convenient and easy to use when compared with using traditional sous vide apparatus.

Using formed food containment wrappers fabricated from malleable, thermally transmissive materials allows opening and closing of the containment wrappers before, during, and/or after food cooking, such as, as a non-limiting and non-exhaustive example, to add or remove ingredients, or manipulate foods, or perform other culinary procedures during cooking. Such food containment wrappers also allow, without their removal: refrigeration, freezing, heating, and reheating of foods contained within the wrappers. Such wrappers also may be used without removal, or additional enclosure, to store leftovers, or for longer term freezer storage, or for other reasons.

When there is a substantial duration, as a non-limiting and non-exhaustive example of perhaps several hours, between when a user first turns on embodiment 300 and when the food in embodiment 300 is served, during this period, microbial growth and food spoilage for other reasons may occur.

As a non-limiting and non-exhaustive example, to help prevent food spoilage, when embodiment 300 is first turned on, the temperature within cooking chamber 312 may be raised to a temperature, and for a duration, sufficient to pasteurize the food being cooked. This may be at a sous vide cooking temperature, or it may be some other temperature or combination of temperatures.

During this pasteurization period, the food may be fully cooked, or partially cooked, or virtually not cooked it all.

After this, embodiment 300 lowers its cooking chamber 312 temperature to a point where cooking is greatly reduced or is terminated. This helps to prevent the food from being overcooked while it is waiting to be served and/or cooked.

Finally, the temperature within cooking chamber 312 is raised to a temperature or temperatures to finish cooking the food. This may, or may not, include temperatures high enough to color outer surfaces of foods being cooked.

This may be at the sous vide cooking temperature, or a higher heat food coloring temperature, or the sous vide cooking temperature followed by the higher heat food coloring temperature; or some other useful temperature or sequence of temperatures.

Temperature probe 404 (FIG. 14) connected to controls 302 (FIG. 1) may help in more precisely controlling the sous vide cooking process by measuring actual internal food temperatures rather than relying simply on cooking times and temperatures. One or more such temperature probes may be used.

Herein, pasteurization refers to a process of partial or full sterilization involving heat treatment.

Ready light 350, on controls 302, in this example, would come be on starting at 6:00 PM, and would not turn off until 10:00 PM, indicating that food is ready to be served during this period.

This 4 hour perfect sous vide serving period (between 6 PM and 10 PM) may be expanded at least by adding low temperature (below 125° F.) heat to cooking chamber 312 after sous vide cooking cuts off 10:00 PM, thus keeping the food at serving temperature for an indefinite or a specified period of time thereafter.

This method of first placing food inside a cooking device and then immediately heat pasteurizing it so that it won't spoil even if cooking commences hours later, is adaptable to many other cooking appliances including at least: traditional sous vide appliances, kitchen ovens, toaster ovens, countertop ovens, food steamers, pressure cookers, microwave ovens, electric grills, waffle irons, electric fry pans, roaster ovens in other food preparation devices.

Calculating when to start steps in a cooking program based on an inputted serving time and an input of the type of food being cooked, greatly simplifies setting up embodiment 300, especially when comparing it to traditional sous vide.

What is claimed is:

1. A method to sous vide cook foods, comprising:
enclosing foods within a sheet formed, thermally transmissive, food containment wrapper which has face-to-face contact with the enclosed foods; and
placing the wrapper and enclosed foods into a fluid filled cooking chamber,
receiving user input setting cooking parameters for the foods,
in accordance with received cooking parameters;
heating the fluid within the cooking chamber for durations and at temperatures sufficient to pasteurize the food,
reducing fluid temperatures within the cooking chamber so that cooking of the foods is curtailed for a cooking parameter directed period of time,
heating fluid within the chamber to cooking temperatures for a time period needed, if any, to fully cook the food, and
removing the food from the chamber and serving it;
wherein spoilage of the foods before they are finally cooked is prevented by the foods being initially pasteurized.

2. The method of claim 1, further including the food cooking parameters being inclusive of a projected food serving time.

3. The method of claim 1, further including, heating the enclosed food to temperatures above boiling for a duration sufficient to thermally color outer food surfaces.

4. The method of claim 1, further including the fluid within the cooking chamber comprised of air.

5. The method of claim 1, further including, heating the foods to cooking temperatures for a duration or durations sufficient to either partially cook, or fully cook, the foods.

6. The method of claim 1, further including, heating the fluid to food serving temperatures.

7. A device to assist in sous vide cooking of foods, comprising:
a food containing wrapper, fabricated from malleable, thermally transmissive, sheet material,
the malleable wrapper being mechanically deformed to cause face-to-face contact with exterior surfaces of food being cooked,
a fluid filled cooking chamber configured to contain the food holding wrapper, and to provide heat to fluid within the chamber, for durations, and at specified sous-vide cooking temperatures,
wherein the traditional, pliable, plastic, vacuum sealed, sous vide bags, which are held against exterior food surfaces through vacuum, are replaced by formed, malleable sheet, wrappers, which are mechanically deformed to structurally contour face-to-face against exterior food surfaces.

8. The device of claim 7, further including the chamber being configured to heat fluid within the chamber to directed thermal food coloring temperatures above boiling, for durations sufficient to cause thermal coloring of outer food surfaces.

9. The device of claim 8, further including a user input configured to direct a degree of thermal coloring to be received by outer food surfaces.

10. The device of claim 7, further including the device having a user input which includes a projected food serving time.

11. The device of claim 7, further including fluid within the cooking chamber being propelled by a motor driven impeller.

12. The device of claim 7, further including the food containment wrapper being coated on its interior surfaces with a direct-food-contact-safe coating.

13. The device of claim 7, further including the food containment wrapper being coated on its interior surfaces with a nonstick coating.

14. The device of claim 7, further including the cooking chamber having a floor, and the food filled containment wrapper being supported in open air on projections above the floor.

15. The device of claim 7, further including the food filled containment wrapper being vented to outside air.

16. The device of claim 7, further including the cooking fluid being air.

17. A food containing wrapper for use in sous vide cooking, comprising:
a food enclosure wrapper configured to contain food glass it is being cooked in a sous vide cooking environment, and
the wrapper being vented, thus allowing fluid communication between the interior and the exterior of the wrapper,
whereby, the wrapper is configured to help maintain its face-to-face contact with enclosed foods being cooked, by the wrapper having vents which allow thermally expanding internal gases during cooking to escape.
